(19) United States
(12) Patent Application Publication
(10) Pub. No.: US 2011/0072826 A1
(43) Pub. Date: Mar. 31, 2011

(54) CAN TO CAN MODAL DECOUPLING USING CAN-LEVEL FUEL SPLITS

(75) Inventors: Venkateswarlu Narra, Greenville, SC (US); Lewis Berkley Davis, Jr., Niskayuna, NY (US); Fei Han, Clifton Park, NY (US); Kwanwoo Kim, Greer, SC (US); Kapil Kumar Singh, Rexford, NY (US); Shiva Kumar Srinivasan, Greer, SC (US); Krishna Kumar Venkataraman, Simpsonville, SC (US)

(73) Assignee: GENERAL ELECTRIC COMPANY, Schenectady, NY (US)

(21) Appl. No.: 12/567,534

(22) Filed: Sep. 25, 2009

(51) Int. Cl. F02C 7/228

(52) U.S. Cl. 60/772; 60/39.37; 60/739

(57) ABSTRACT

In exemplary embodiments, a gas turbine system is provided. The gas turbine system can include a compressor configured to compress air and combustor cans in flow communication with the compressor, the combustor cans being configured to receive compressed air from the compressor and to combust a fuel stream. The gas turbine system can also include a multi-circuit manifold coupled to the combustor cans and configured to provide a split fuel stream from the fuel stream to the combustor cans.

### BACKGROUND OF THE INVENTION

The subject matter disclosed herein relates to gas turbines and more particularly to can combustor de-tuning and frequency de-coupling via multi-circuit fuel manifolds.

In a gas turbine, multi-can combustors communicate with each other acoustically due to connections between various cans. Large pressure oscillations, also known as combustion dynamics, result when the heat release fluctuations in the combustor couple with the acoustic tones of the combustor. Some of these combustor can acoustic tones may be in phase with the adjacent can, while other tones could be out of phase with the adjacent can. In-phase tones are particularly a concern because of their ability to excite the turbine blades in the hot gas path if they coincide with the natural frequency of the blades impacting the blade life. The in-phase tones are particularly of concern when the instabilities in different cans are coherent (i.e., there is a strong relationship in the frequency and the amplitude of the instability in one can to the next can). Such coherent in-phase tones can excite the turbine buckets leading to durability issues and thereby limiting the operability of the gas turbine, and can ultimately crack the turbine buckets.

Current solutions to the potential damaging in-phase coherent tones are to ensure that the in-phase coherent tones near the bucket natural frequency are of much smaller amplitude compared to the typical design practice limits. This approach means that the operability space could be limited by the in-phase coherent tones. Another current approach includes changing the fuel splits to either shift the combustor instability frequency away from the turbine blade natural frequency or to lower the amplitude.

### BRIEF DESCRIPTION OF THE INVENTION

In exemplary embodiments, a gas turbine system is provided. The gas turbine can include a compressor configured to compress air and combustor cans in flow communication with the compressor, the combustor being configured to receive compressed air from the compressor and to combust a fuel stream. The gas turbine can also include a multi-circuit manifold coupled to the combustor cans and configured to provide a split fuel stream from the fuel stream to the combustor cans.

In exemplary embodiments, a gas turbine is provided. The gas turbine can include a first group of combustor cans, a second group of combustor cans and fuel nozzles disposed in each of the first group and second group of combustor cans. The gas turbine can further include a multi-circuit manifold coupled to the first group of combustor cans and the second group of combustor cans.

In exemplary embodiments, a method of decoupling in-phase coherent tones between the first and second combustor cans in a gas turbine, the first and second combustor cans having groups of fuel nozzles. The method can include providing a fuel stream to the first and second combustor cans and splitting the fuel stream in at least one of, between the first and second combustor cans and between the groups of nozzles in both the first and second combustor cans.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 diagrammatically illustrates a side view of a gas turbine system in which exemplary multi-circuit manifolds can be implemented.

FIG. 2 diagrammatically illustrates the gas turbine system of FIG. 1 including an exemplary multi-circuit manifold configuration coupled to the combustor cans.

FIG. 3 diagrammatically illustrates a front view of an exemplary multi-circuit manifold configuration similar to the multi-circuit manifold of FIG. 2.

FIG. 4 illustrates a front perspective view of an example of a nozzle arrangement within a combustor can.

FIG. 5 diagrammatically illustrates an example of groupings of fuel nozzles within a combustor can.

FIG. 6 diagrammatically illustrates an exemplary multi-circuit manifold configuration.

FIG. 7 diagrammatically illustrates a front view of an exemplary multi-circuit manifold configuration.

FIG. 8 illustrates an example of a time series data plot of pressure versus time for an out of phase tone in a gas turbine.

FIG. 9 illustrates an example spectra plot of amplitude versus frequency for the out of phase tone of FIG. 8.

FIG. 10 illustrates an example of a time series data plot of pressure versus time for an in-phase tone in a gas turbine.

FIG. 11 illustrates an example spectra plot of amplitude versus frequency for the in-phase tone of FIG. 10.

FIG. 12 illustrates a flow chart of a method of decoupling in-phase tones between the first and second combustor cans in a gas turbine.

The detailed description explains embodiments of the invention, together with advantages and features, by way of example with reference to the drawings.

### DETAILED DESCRIPTION OF THE INVENTION

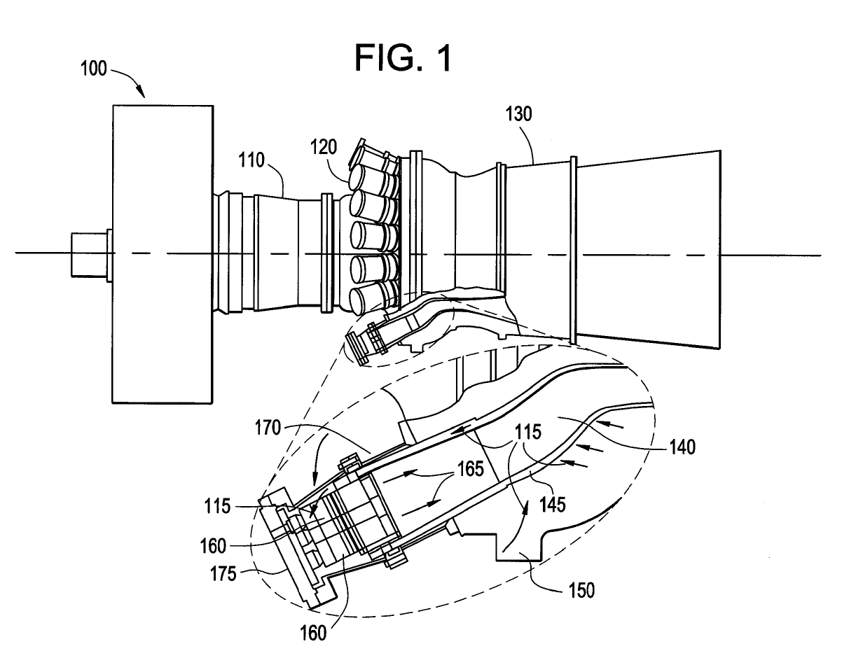

FIG. 1 diagrammatically illustrates a side view of a gas turbine system 100 in which exemplary multi-circuit manifolds can be implemented. In exemplary embodiments, the gas turbine 100 includes a compressor 110 configured to compress ambient air. One or more combustor cans 120 are in flow communication with the compressor 110 via a diffuser 150. The combustor cans 120 are configured to receive compressed air 115 from the compressor 110 and to combust a fuel stream from fuel nozzles 160 to generate a combustor exit gas stream 165 that travels through a combustion chamber 140 to a turbine 130. Part of the combustion chamber 140 is included in a transition piece 145 that is coupled to the combustor cans 120. The turbine 130 is configured to expand the combustor exit gas stream 165 to drive an external load. The combustor cans 120 include an external housing 170, and an end cap 175 configured to couple with fuel hoses (not shown) from a fuel manifold (not shown). Currently, a single fuel manifold provides a single fuel flow to the end caps 175 of each of the combustor cans 120 and thus to the fuel nozzles 160.

As described herein, adjacent combustors cans 120 communicate with each other acoustically through an opening at the exit of the transition piece 145 and a first stage of the turbine 130. When the heat release fluctuations in the combustor cans 120 couple with combustor acoustic tones they tend to excite either an in-phase or an out of phase tone or both. In exemplary embodiments, the system 100 can include a multi-circuit manifold configured to detune the strong acoustic interactions (e.g., coupling of acoustic modes of adjacent cans) between the combustor cans 120 thereby shifting the frequencies of instability in the adjacent cans or decreasing the amplitude by reducing the combustion-acoustic interaction and reducing the coherence of the in-phase mode.

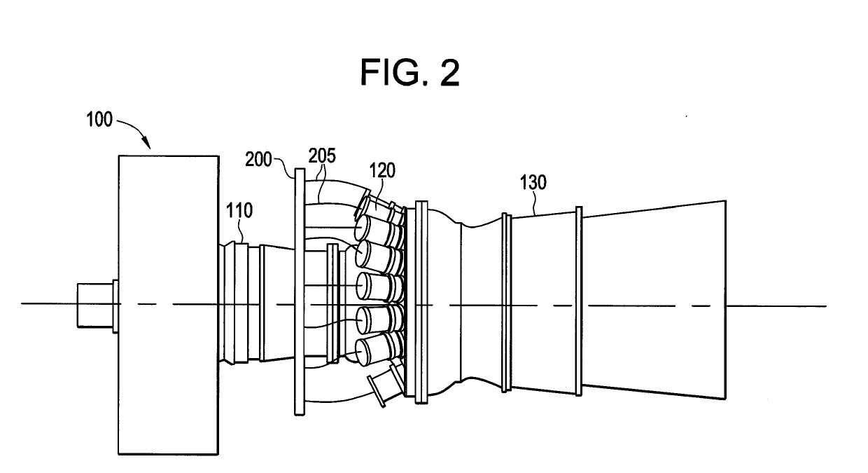

FIG. 2 diagrammatically illustrates the gas turbine system 100 of FIG. 1 including an exemplary multi-circuit manifold configuration 200 coupled to the combustor cans 120. In exemplary embodiments, the manifold configuration includes fuel lines 205 that provide fuel from the manifold 200 to the combustor cans 120, thus intentionally introducing variation in operating conditions in the adjacent cans. In exemplary embodiments, the multi-circuit manifold 200 fuels adjacent cans from individual fuel manifolds included in the multi-circuit manifold 200. In this way, adjacent fuel combustor cans can be fueled at different rates and direct control at the combustor can level to change the fuel split can be achieved. By adjusting the rates of the fuel flow to adjacent cans, the resulting frequencies, and thus the in-phase and out of phase tones, can also be controlled. Changing the fuel splits between adjacent cans changes the fuel system impedance and unstable frequencies in adjacent cans, which impacts the flame acoustic interaction and thereby shifts the instability frequencies in adjacent cans, lowers the instability amplitude, and thus disrupts the strong coherent relationship between the cans. In addition to changing fuel system impedance, varying combustor temperature between adjacent cans induces instability frequency differences, which in turn disrupts the strong coherence across cans. This asymmetry or de-synchronization results in suppressing the ability of the unstable tone to drive the turbine blades. In exemplary embodiments, in the event of a gas turbine turndown, one or more of the manifolds in the multi-circuit manifold can be turned off to turn off alternate cans.

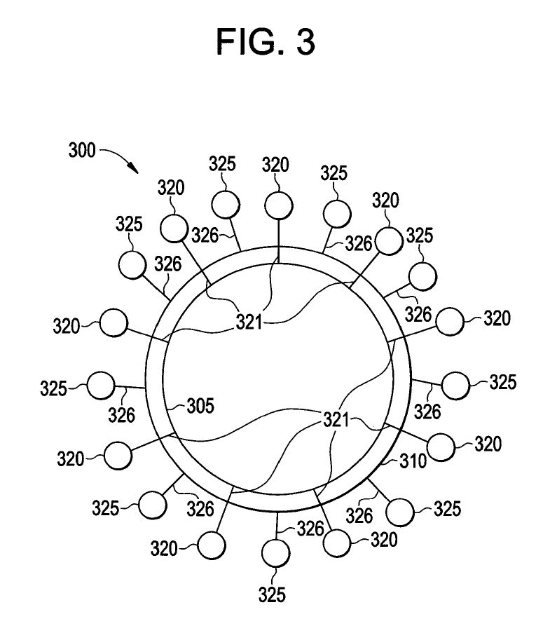

FIG. 3 diagrammatically illustrates a front view of an exemplary multi-circuit manifold configuration 300 similar to the multi-circuit manifold 200 of FIG. 2. In exemplary embodiments, the multi-circuit manifold configuration 300 can include a first manifold 305 and a second manifold 310 concentric with the first manifold 305. The first manifold 305 includes a first set of combustor cans 320 coupled to the first manifold 305 via fuel lines 321. The second manifold 310 includes a second set of combustor cans 325 interleaved and adjacent to each of the first set of combustion cans 320. The second set of combustion cans 325 are coupled to the second manifold 310 via fuel lines 326. It to be appreciated that combustor cans can include multiple nozzles within the combustor cans as illustrated, for example, in FIG. 1 (i.e., combustor can 120 shows nozzles 160) and described further herein. In the multi-circuit manifold configuration 300 example of FIG. 3, the fuel lines 321 provide fuel from the first manifold 305 to all nozzles within the first set of combustor cans 320. Similarly, the fuel lines 326 provide fuel from the second manifold 310 to the second set of combustor cans 325. It is therefore appreciated that the multi-circuit manifold configuration 300 provides a first fuel stream to the first set of combustor cans 320 and a second fuel stream to the second set of combustor cans 325. As described herein, the first set of combustor cans 320 can be fueled at a different rate than the second set of combustor cans 325. By having two separate manifolds 305, 310, the fuel split to the respective first and second set of combustor cans 320, 325 can be controlled. By adjusting the rates of the fuel flow to one or both of the first and second sets of combustor cans 320, 325, the instability frequencies can be adjusted and controlled. By having control of the fuel splits with the first and second manifolds 305, 310, the flame acoustic interactions in the first and second sets of combustors is controlled to shift the instability frequencies and their tendency to drive to higher amplitudes, thereby disrupting the strong coherent relationships between the first and second sets of combustor cans 320, 325.

As described above, in-phase coherent combustion tones are a concern because of their ability to excite the turbine buckets. By having two manifolds in the multi-circuit manifold configuration 300 as described, the gas turbine can have can-level fuel split management to suppress the in-phase coherent nature of the gas turbine. By fueling the adjacent cans differently, the fuel system impedance and combustor temperature are modified and thus the flame-acoustic wave interactions and the instability frequency are influenced. The coherence of the instability around the gas turbine is thus reduced, accompanied by reduction in the instability amplitude, which in turn suppresses the ability of the tone to drive the turbine buckets, thereby reducing the chance of damage to the turbine buckets. It is to be appreciated that the grouping of combustor cans into two groups is just an example. In other exemplary embodiments, the combustor cans are grouped into additional adjacent groups.

Each combustor can includes multiple fuel nozzles. In exemplary embodiments, nozzles in all combustor cans can be grouped together for fuel split management and thus combustor can control and management. Each group of nozzles can be referred to as a circuit and a particular circuit can be fed fuel from a single manifold. In this way, each combustor can receives fuel from all manifolds but to different circuits within the combustor can.

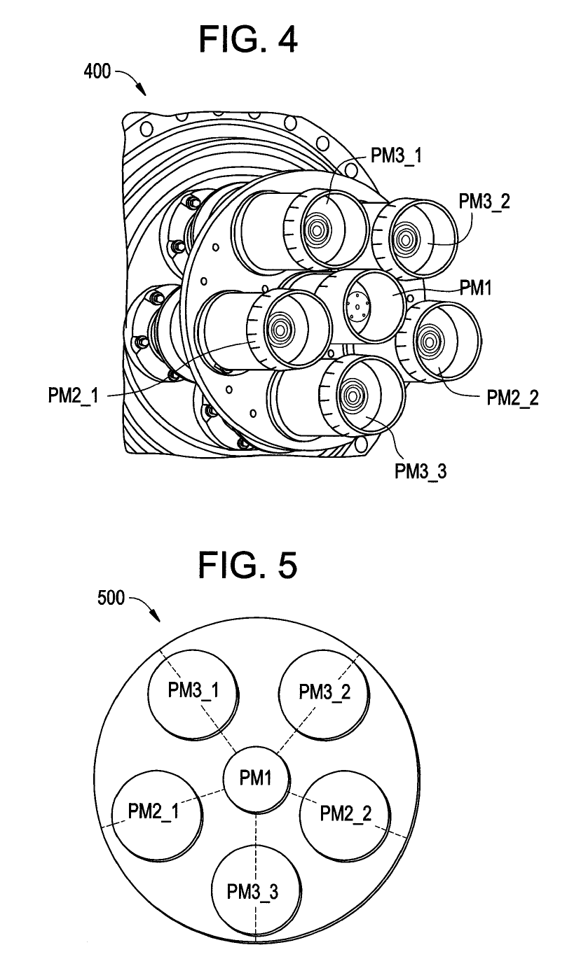

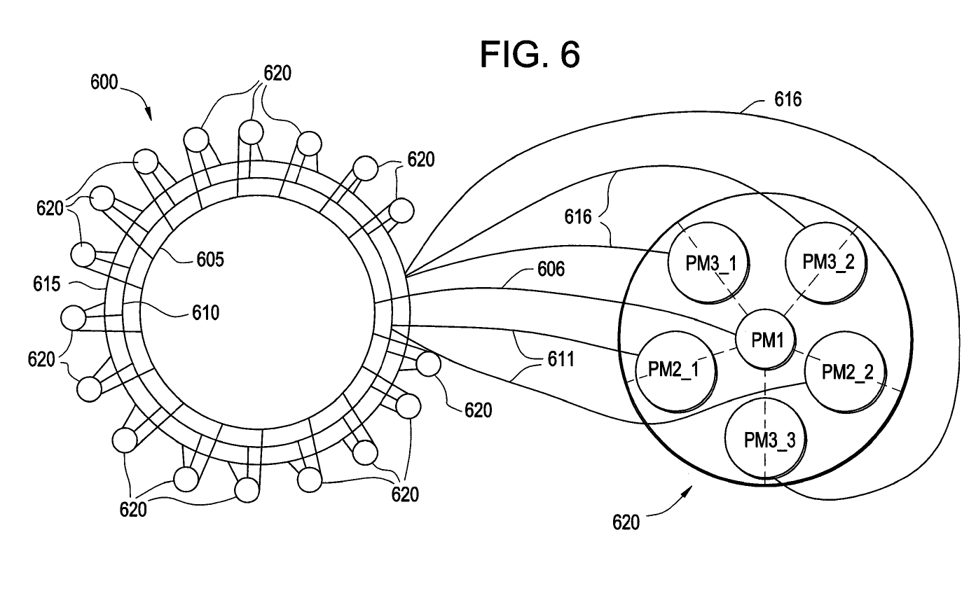

FIG. 4 illustrates a front perspective view of an example of a nozzle arrangement 400 within a combustor can (e.g., 320, 325 in FIG. 3). It is to be appreciated that the number and groupings of nozzles described herein is used as an illustrative example. It is to be appreciated that other numbers and groupings of the nozzles are contemplated in alternate exemplary embodiments. The nozzle arrangement includes a center nozzle PM1, a first group of outer nozzles PM2_1, PM2_2, and a second group of outer nozzles PM3_1, PM3_2, PM3_3. FIG. 5 diagrammatically illustrates groupings 500 of the nozzles, PM1, PM2_1, PM2_2, PM3_1, PM3_2, PM3_3 within a combustor can. FIG. 6 diagrammatically illustrates a front view of an exemplary multi-circuit manifold configuration 600. The multi-circuit manifold configuration 600 includes a first manifold 605, a second manifold 610 and a third manifold 615. The manifolds 605, 610, 615 are each coupled to combustor cans 620. For illustrative purposes one of the combustor cans 620 is diagrammatically illustrated showing the group of nozzles as shown in FIG. 5 to illustrate the coupling of fuel lines 606, 611, 616 to the manifolds 605, 610, 615. In exemplary embodiments, the first manifold 605 is coupled to each of the combustor cans 620 via a fuel line 606. The second manifold 610 is coupled to each of the combustor cans 620 via fuel lines 611. The third manifold is coupled to each of the combustor cans 620 via fuel lines 616. It is further appreciated that in the multi-circuit configuration 600, the fuel line 606 feeds the nozzle PM1 as a first circuit. The fuel lines 611 feed the nozzles PM2_1, PM2_2 as a second circuit. The fuel lines 616 feed the nozzles PM3_1, PM3_2, PM3_3 as a third circuit. It is therefore appreciated that the nozzles are grouped into discrete sub-groups and the multi-circuit manifold configuration provides discrete fuel streams to each of the sub-groups of nozzles.

The multi-circuit manifold configuration 600 addresses the concern of in-phase coherent combustion tones. By grouping nozzles into three circuits in this example, each of the circuits fed by a separate manifold, the gas turbine can have can-level fuel split management to suppress the in-phase coherent nature of the gas turbine. By fueling the groups of nozzles (circuits) differently, the fuel system impedance is modified and thus the flame-acoustic wave interactions and the instability frequency are influenced. In this way, the acoustic interaction and instability frequencies are controlled by controlling the fuel flow to the different circuits, thereby controlling cross talk between adjacent combustor cans via the circuits. The coherence of the instability around the gas turbine is thus reduced, which in turn suppresses the ability of the tone to drive the turbine buckets, thereby reducing the chance of damage to the turbine buckets. It is to be appreciated that the grouping of nozzles into three circuits is just an example. In other exemplary embodiments, the nozzles can be grouped into fewer or more circuits.

The multi-circuit manifold configuration 300 of FIG. 3 illustrates a separate manifold for two groups of adjacent cans. The multi-circuit manifold configuration 600 of FIG. 6 illustrates a separate manifold for each of three groups of nozzles within all combustor cans. In exemplary embodiments, a first group of manifolds can feed fuel to multiple circuits within a first group of combustor cans. Similarly a second group of manifolds can feed fuel to multiple circuits within a second group of combustor each adjacent to cans within the first group.

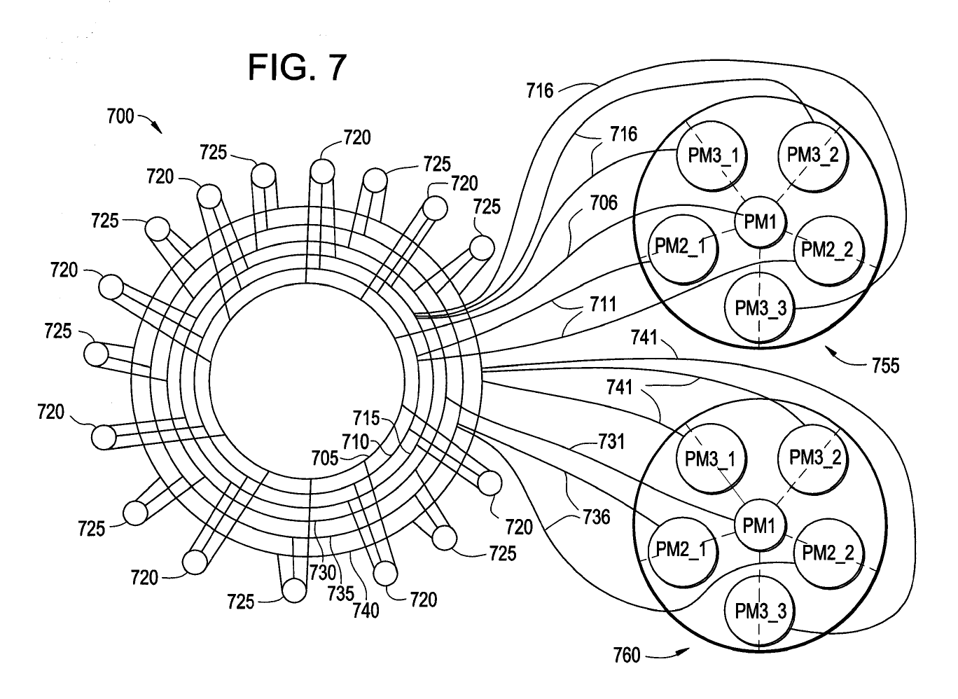

FIG. 7 diagrammatically illustrates a front view of an exemplary multi-circuit manifold configuration 700. The multi-circuit manifold configuration 700 includes a first manifold 705, a second manifold 710, a third manifold 715, a fourth manifold 730, a fifth manifold 735 and a sixth manifold 740. In exemplary embodiments, the second, third, fourth, fifth and sixth manifolds 710, 715, 730, 735, 740 are concentric with the first manifold 705. The manifolds 705, 710, 715 are each coupled to combustor cans 720. The manifolds 730, 735, 740 are each coupled to combustor cans 725. For illustrative purposes one of the combustor cans 720 is diagrammatically illustrated showing a first group of nozzles 755 as shown in FIG. 5 to illustrate the coupling of fuel lines 706, 711, 716 to the first group of manifolds 705, 710, 715. In addition, for illustrative purposes one of the combustor cans 725 adjacent the combustor can 720, is diagrammatically illustrated showing a second group of nozzles 760 as shown in FIG. 5 to illustrate the coupling of fuel lines 731, 736, 741 to the second group of manifolds 730, 735, 740. In exemplary embodiments, the first manifold 705 is coupled to each of the PM1 nozzles of the combustor cans 720 via a fuel line 706. The second manifold 710 is coupled to each of the PM2_1, PM2_2 nozzles of the combustor cans 720 via fuel lines 711. The third manifold 715 is coupled to each of the PM3_1, PM3_2, PM3_3 nozzles of the combustor cans 720 via fuel lines 716. It is therefore appreciated that the first, second and third manifolds 705, 710, 715 form a first group fueling the first combustor cans 720. In addition, each of the manifolds 705, 710, 715 fuels separate groups of nozzles within the combustor cans 720. The fourth manifold 730 is coupled to each of the PM1 nozzles of the combustor cans 725 via a fuel line 731. The fifth manifold 735 is coupled to each of the PM2_1, PM2_2 nozzles of the combustor cans 725 via fuel lines 736. The sixth manifold 740 is coupled to each of the PM3_1, PM3_2, PM3_3 nozzles of the combustor cans 725 via fuel lines 741. It is therefore appreciated that the fourth, fifth and sixth manifolds 730, 735, 740 form a second group fueling the first combustor cans 725. In addition, each of the manifolds 730, 735, 740 fuels separate groups of nozzles within the combustor cans 725. It is therefore appreciated that the multi-circuit manifold configuration therefore provides first fuel streams to the first set of combustor cans 720 and second fuel streams to the second set of combustor cans 725. In addition the first fuel streams provide fuel to discrete sub-groups of nozzles in the first combustor cans 720 and the second fuel streams provide fuel to discrete sub-groups of nozzles in the second combustor cans 725.

The multi-circuit manifold configuration 700 addresses the concern of in-phase coherent combustion tones. By having two groups of manifolds in the multi-circuit manifold configuration 700 as described, as well as grouping nozzles into three circuits within each of the two groups of manifolds, the gas turbine can have can-level fuel split management to suppress the in-phase coherent nature of the gas turbine. By fueling both the groups of nozzles (circuits) within adjacent cans differently, the fuel system impedance and combustor temperature are modified and thus the flame-acoustic wave interactions and the instability frequency are influenced. In this way, the interaction between cans and instability frequencies are controlled by controlling the fuel flow to the different circuits, thereby controlling interaction between adjacent combustor cans via the cans and fuel circuits. The coherence of the instability around the gas turbine is thus reduced, which in turn suppresses the ability of the tone to drive the turbine buckets, thereby reducing the chance of damage to the turbine buckets. It is to be appreciated that the grouping of manifolds into two groups, and grouping the nozzles into three circuits is just an example. In other exemplary embodiments, the manifolds can be grouped into fewer or more groups and the nozzles can be grouped into fewer or more circuits.

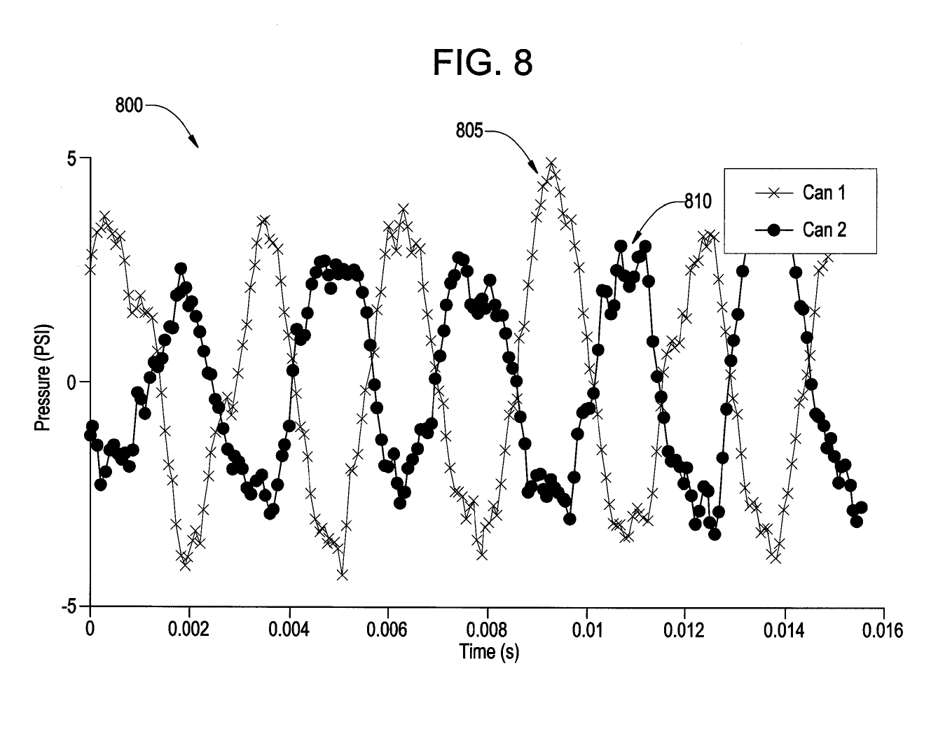

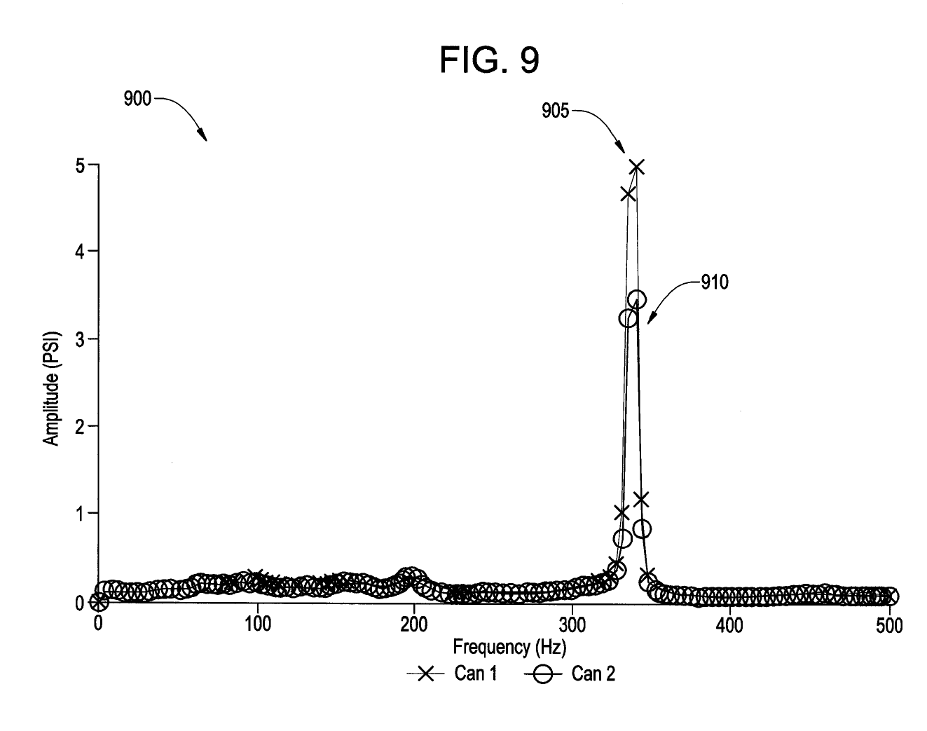

As described herein, out of phase tones are not of the greater concern in gas turbines from the turbine life point of view. FIG. 8 illustrates an example of a time series data plot 800 of pressure versus time for out of phase tone in a gas turbine. FIG. 9 illustrates an example spectra plot 900 of amplitude versus frequency for the push-pull tone of FIG. 8. In this example, the instability tone is at about 340 Hz. The plot 800 illustrates that the tones of the adjacent cans, as indicated by lines 805, 810 tend are out of phase with adjacent combustor can. FIG. 9 illustrates the corresponding spectral lines 905, 910 for combustor can 1 and combustor can 2 respectively.

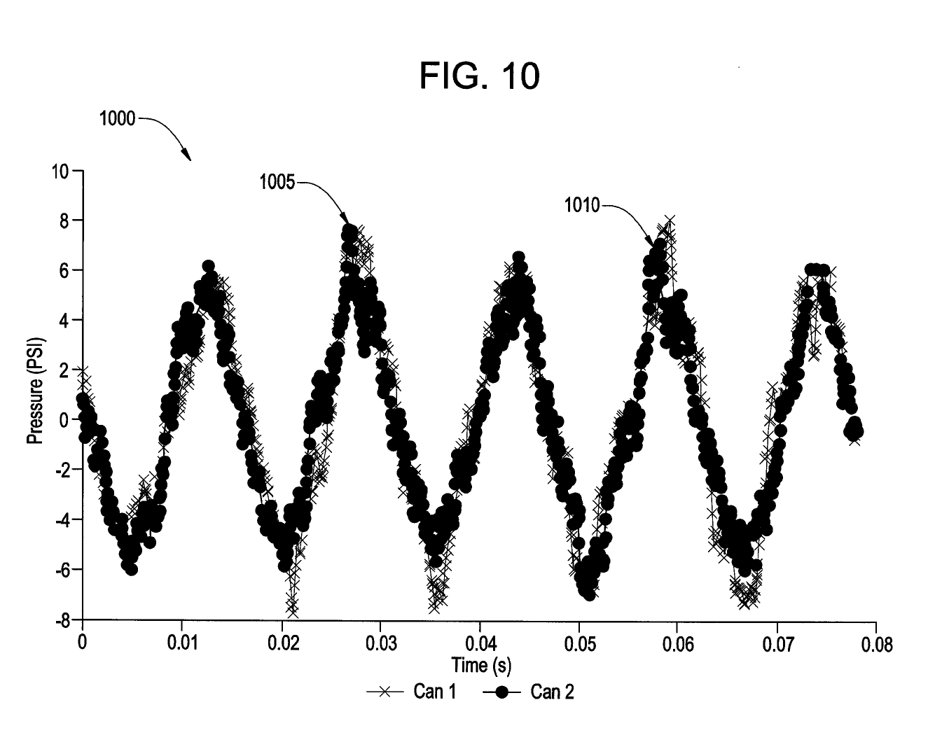

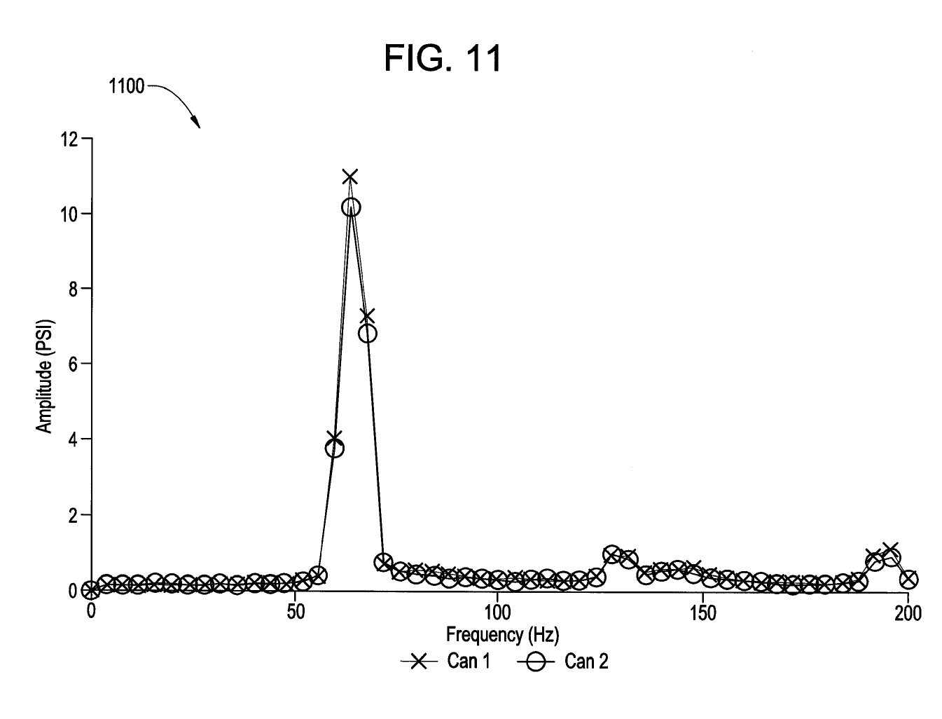

In contrast, when the frequency of the in-phase coherent tones match the natural frequency of turbines buckets, these in-phase tones could potentially cause damage to the turbine buckets. FIG. 10 illustrates an example of a time series data plot 1000 of pressure versus time for an in-phase tone in a gas turbine. FIG. 11 illustrates an example spectra plot 1100 of amplitude versus frequency for the in-phase tone of FIG. 10. In this example, the instability tone is at about 60 Hz. The plot 1000 illustrates that the tones of the adjacent cans, as indicated by lines 1005, 1010 tend to be in phase. When these in-phase tones are strongly coherent between adjacent cans, they can drive the turbine buckets. FIG. 11 illustrates the corresponding spectral lines 1105, 1110 for combustor can 1 and combustor can 2 respectively. The exemplary embodiments described herein therefore adjust the fuel flows, which as described above, can directly affect the tones of adjacent cans, causing a shift in the instability frequencies of adjacent cans, thereby decreasing coherence and thus reducing the ability of the tones to drive the turbine buckets.

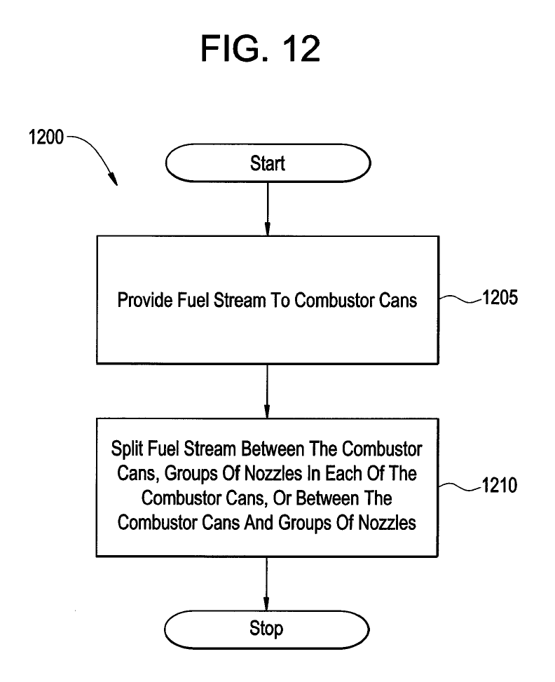

FIG. 12 illustrates a flow chart of a method 1200 of decoupling in-phase tones between the first and second combustor cans in a gas turbine. At block 1205, a fuel stream is provided to the first and second combustor cans such as the combustor cans 320, 325. At block 1210, the fuel stream is split as discussed herein. In exemplary embodiments, the fuel stream is split between two manifolds 305, 310 supplying a first stream to the first combustor cans 320 and a second fuel stream to the second combustor cans as in FIG. 3. In exemplary embodiments, the fuel stream is split between groups of fuel nozzles such as PM1, PM2_1, PM2_2, PM3_1, PM3_2, PM3_3 in combustors 620 as in FIG. 6. In exemplary embodiments, the fuel stream is split between adjacent combustor cans such as combustor cans 720, 725 in FIG. 7. In addition, the fuel stream is split among groups of nozzles PM1, PM2_1, PM2_2, PM3_1, PM3_2, PM3_3 in each of the combustor cans 720, 725.

It is to be appreciated that many acoustical instabilities observed in the combustor near the turbine bucket natural frequencies is a design and operability concern and thus can be subject to stringent design limits. Thus, the ability to control the system level behavior of the in-phase coherent frequencies, for example, results in exercising more design options and improved operability space by eliminating these restrictions. As such, increased designs and operability can be considered in gas turbines. In addition, the combustion system can be optimized, to a large extent, independent of turbine structural design. It is to be appreciated that the exemplary embodiments described herein can address other acoustical instabilities that can be controlled by managing the fuel flows into combustor cans thereby providing active mitigation of a variety of acoustical instabilities.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A gas turbine system, comprising:
a compressor configured to compress air;
a plurality of combustor cans in flow communication with the compressor, the plurality of combustor cans being configured to receive compressed air from the compressor and to combust a fuel stream; and
a multi-circuit manifold coupled to the plurality of combustor cans and configured to provide a split fuel stream from the fuel stream to the plurality of combustor cans.

2. The system as claimed in claim 1 wherein the fuel stream provides a different fuel flow rate to each of the plurality of combustor cans.

3. The system as claimed in claim 2 wherein the plurality of combustor cans includes a first group of combustor cans and a second group of combustor cans, wherein each combustor can of the first group of combustor cans is adjacent to a combustor can of the second group of combustor cans, wherein the first group of combustor cans has a first temperature and the second group of combustor cans has a second temperature.

4. The system as claimed in claim 3 wherein the multi-circuit manifold includes a first manifold and a second manifold.

5. The system as claimed in claim 4 wherein the first manifold provides a first fuel stream to the first group of combustor cans and the second manifold provides a second fuel stream to the second group of combustor cans.

6. The system as claimed in claim 1 further comprising a plurality of fuel nozzles disposed in each of the plurality of combustor cans.

7. The system as claimed in claim 6 wherein the plurality of nozzles includes a first group of nozzles and a second group of nozzles.

8. The system as claimed in claim 7 wherein the multi-circuit manifold includes a first manifold and a second manifold.

9. The system of claim 8 wherein the first manifold provides a first fuel stream to the first group of nozzles and the second manifold provides a second fuel stream to the second group of nozzles.

10. The system as claimed in claim 6 wherein the plurality of combustor cans includes a first groups of combustor cans and a second group of combustor cans, and wherein the plurality of nozzles are grouped into discrete sub-groups within each combustor can.

11. The system as claimed in claim 10 wherein the multi-circuit manifold provides first fuel streams to the first group of combustor cans and second fuel streams to the second group of combustor cans.

12. The system as claimed in claim 11 wherein the first fuel streams are split among the discrete sub-groups of nozzles within the first group of combustor cans and the second fuel streams are split among the discrete sub-groups of nozzles within the second group of combustor cans, the first fuel streams providing different fuel rates to each of the first group of combustor cans and the second fuel streams providing different fuel rates to each of the second group of combustor cans.

13. A gas turbine system, comprising:
a first group of combustor cans;
a second group of combustor cans;
fuel nozzles disposed in each of the first groups and second group of combustor cans; and
a multi-circuit manifold coupled to the first group of combustor cans and the second group of combustor cans.

14. The system as claimed in claim 13 wherein the multi-circuit manifold is configured to provide a first fuel stream to the first group of combustor cans and a second fuel stream to the second group of combustor cans.

15. The system as claimed in claim 13 wherein the multi-circuit manifold is configured to provide multiple fuel streams to multiple sub-groups of nozzles in the first group of combustor cans and the second group of combustor cans.

16. The system as claimed in claim 13 wherein the multi-circuit manifold is configured to provide first fuel streams to multiple sub-groups of fuel nozzles in the first group of combustor cans and second fuel stream to multiple sub-groups of fuel nozzles in the second group of combustor cans.

17. In a gas turbine having a first combustor can adjacent to a second combustor can, the first and second combustor cans having groups of fuel nozzles, a method of decoupling in-phase coherent tones between the first and second combustor cans, the method comprising:
providing a fuel stream to the first and second combustor cans; and
splitting the fuel stream at least one of between the first and second combustor cans and between the groups of nozzles in both the first and second combustor cans.

18. The method as claimed in claim 17 wherein the fuel stream is split between the first and second combustor can.

19. The method as claimed in claim 17 wherein the fuel stream is split among the groups of fuel nozzles in each of the first and second combustor cans.

20. The method as claimed in claim 17 wherein the fuel stream is split between the first and second combustor cans and among the groups of fuel nozzles.
